(19) United States
(12) Patent Application Publication
(10) Pub. No.: US 2007/0216537 A1
(43) Pub. Date: Sep. 20, 2007

(54) ALARM MECHANISM WITH SILENT ALARM WRISTBAND

(76) Inventor: John Park, Wilmington, DE (US)

Correspondence Address: QUICKPATENTS, INC., 32861 CALLE PERFECTO, SUITE A, SAN JUAN CAPISTRANO, CA, 92675, US

(21) Appl. No.: 11/308,301

(22) Filed: Mar. 15, 2006

(51) Int. Cl. G08B 3/00; G08B 23/00

(52) U.S. Cl. 340/691.1; 340/573.1

(57) ABSTRACT

An alarm system attached to a user's body with silent alarm capability and responsive to wake-up alarms and to emergency sensors such as intrusion detectors. The user is wakened with a silent and safe local electric shock in response to a base unit wireless connection. The base unit utilizes an internal alarm clock and interfaces with a large variety of sensors and detectors, and may be programmed by the user for personal preferences. A vibration awakening means may be used in conjunction with the electric shock awakening means.

### CROSS-REFERENCE TO RELATED APPLICATIONS

Not applicable.

### STATEMENT REGARDING FEDERALLY SPONSORED RESEARCH AND DEVELOPMENT

This invention was made without the assistance or financial support from any federal agency or its agents.

### FIELD OF THE INVENTION

This invention relates to emergency notification systems and alarms, and in particular to silent alarm applications.

### DISCUSSION OF RELATED ART

Heretofore in the fields of emergency notification and temporal schedule alerts such as alarm clocks and remote facility notification, both audible and visual alarms have been employed. For example in burglary and intrusion detection, centralized response personnel, burglar alarms and visual indicators such as flashing lights and perimeter lighting are employed. When a deep sleeper requires awakening, well-known alarm clocks and the like and in some cases silent alarms are utilized. Vibrating mechanisms have been proposed to silently awaken a targeted sleeper in order to avoid awaking others and for the deaf.

For example, U.S. Pat. No. 5,764,594 to Berman et al teaches a portable wrist-watch type configuration vibrating awakener coupled through radio signals to an alarm clock. Generally, vibrating awakeners require excessive energy for small portable devices. Giani in U.S. Pat. No. 5,686,882 proposes rechargeable batteries and an induction charger coupled to an alarm clock through radio waves or ultrasonic coupling.

U.S. Pat. No. 4,967,695 to Giunta describes methods in perimeter fencing using radio transmission to a receiving collar for behavioral modification of dogs using electrical shock and three orthogonally oriented antennas with logic to insure reception of the radio frequency (RF) transmission for substantially any orientation of the receiver unit.

U.S. Pat. No. 6,151,278 to Najarian teaches remote vibrating devices coupled to an alarm clock circuit through encoded radio waves to minimize false alarms.

The energy required for vibration devices sufficient to awake users in deep sleep is excessive. Portable silent user notification of emergency situations is also desirable so that, for example, in the case of a burglary or intrusion, the sleeper is given an opportunity to take appropriate defensive and/or evasive action.

Therefore, there is a need for an effective low-energy awakening device coupled to alarm clock circuitry and to emergency detection sensors. The present invention accomplishes these objectives.

### SUMMARY OF THE INVENTION

The present invention provides a painless and safe, but effective, localized electric shock to awaken a sleeper. The shock may be provided, for example, via a wrist watch-like device or wristband in wireless communication and cooperation with an electronic alarm device base unit, through closely-spaced electrodes held against the skin by a wrist engaging strap to insure localization of current flow. As such, the shock is safe yet sufficient to strongly stimulate sensory nerves. Such an electric current involves low energy relative to mechanical vibrating devices, and yet provides a more dramatic and effective stimulation.

A deactivation button similar to a well-known ‘snooze’ button on an alarm clock is provided for a first category alarm such as the alarm clock function and any non-urgent sensor alarm. Such deactivation button is provided on the portable device and its characteristics may be adjusted based upon the type of notification proffered. For example, if the notification is from a second category such as a smoke detector, fire alarm, intrusion detector, and the like, the deactivation button may be made ineffective, and the user must disable the notification signal at the base unit master deactivation switch, indicating immediately to the user that the alarm is of an urgent and emergency nature. The electric shock may be provided in a predetermined increasing intensity until deactivation is accomplished, with a physiologically safe upper limit. Additionally, to provide redundancy, alternate preferred embodiments may include vibratory stimulation in addition to electric shock, and for certain alarm situations, such as smoke-detection, CO detection, flooding, natural gas detection, burglar detection, fire detection and the like, the electric shock may be supplemented with audible and visual alarms, and remote notification of emergency responders.

The present invention is a portable electric shock stimulator responsive to alarm clock circuitry, fire detection, smoke detection, carbon monoxide detection, intrusion detection, flooding detection, low medical oxygen pressure detection, gas leak detection, and the like, with further provision for connection to any desirable sensor appropriate for awakening a sleeping user. Additionally, the device may be used for human behavioral modification, such as smokers desiring to eliminate their habit. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective diagram of a sleeping person using the system of the present invention, and illustrating an electronic alarm device, or base unit, in wireless communication and cooperation with a silent alarm wristband attached to the sleeping persons wrist;

FIG. 2 is an expanded perspective view of the sleeping persons arm taken generally along line 2-2 of FIG. 1 and illustrates the silent alarm wristband;

FIG. 3 is a perspective view of the silent alarm wristband in detail;

FIG. 4 is a functional block diagram of the silent alarm wristband of the invention; and

FIG. 5 is a functional block diagram of sensors in wired or wireless connection with the base unit.

### DETAILED DESCRIPTION OF THE PREFERRED EMBODIMENT

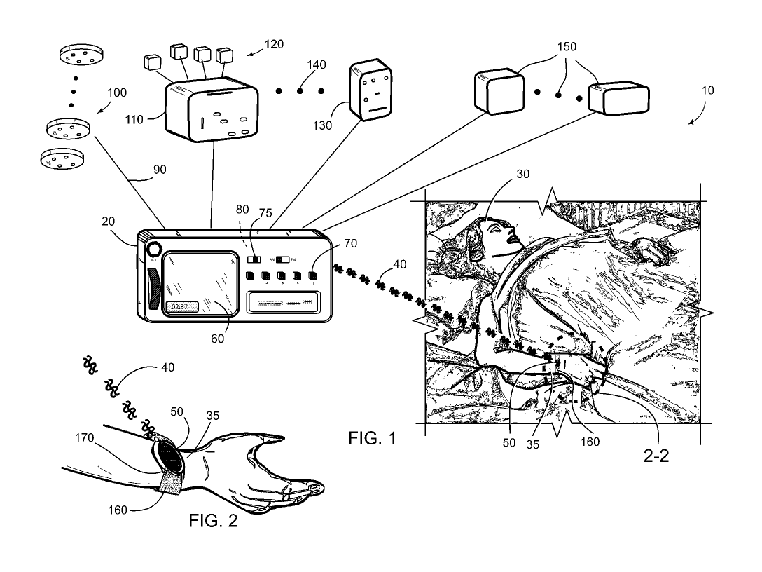

Referring to FIG. 1, an alarm mechanism with a silent alarm wristband system 10 of the invention is depicted in use. A base unit 20, which is an electronic alarm device, includes display 60, functional and parametric pushbuttons 70 for programming the system, and a clock circuit 80 internal thereto. A sleeping person 30 is illustrated wearing a silent alarm wristband 50 attached to her wrist 35 with a wrist engaging strap 160. Silent alarm wristband 50 receives wireless communication radio waves 40 from base unit 20. Wireless communication radio waves 40 contain information relating to the type of alarm being issued and various parameters programmed in the base unit 20, it being understood that other preferred embodiments utilize other wireless communication signals, such as infrared light or ultrasonic sound waves, or the like. Base unit 20 receives wired or wireless sensor status 90 from a variety of sensors, such as a number of smoke sensors 100, an intrusion and burglar alarm subsystem 110 responsive to a number of intrusion and burglar sensors 120, a medical oxygen supply low pressure sensor 130, a number of optional sensors and detectors 140, and a number of potential future unknown optional sensors and detectors 150. Master deactivation switch 75 disables the alarm at base unit 20.

FIG. 2 illustrates an expanded view of the arm of sleeping person 30 and depicts the silent alarm wristband 50 of the invention attached to the wrist 35 with wrist engaging strap 160 to substantially ensure that electrical contact of underside electrodes 220, described below, is established. Wireless communication radio waves 40 are cooperatively received by silent alarm wristband 50. Deactivation button 170 allows a user to deactivate the wristband for certain first category alarms and is ineffective for certain other second category alarms such as smoke detection, intrusion, fire detection, and the like. For a wake-up alarm the deactivation button 170 operates in a manner similar to a ‘snooze’ function on a normal alarm clock-radio in that after a predetermined time, such as ten minutes, the alarm can be programmed to reactivate. These variable parameters are communicated from base unit 20 to silent alarm wristband 50 through wireless communication radio waves 40 in a preamble data stream, not shown, and is well known in the art.

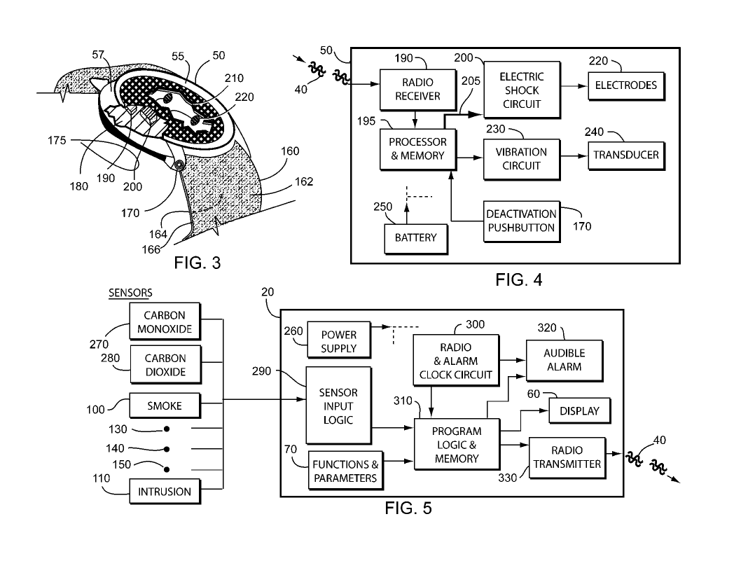

Referring to FIG. 3, the silent alarm wristband 50 further includes an electronic circuit 175 comprising a silent alarm wristband circuit board 180 with support circuitry (not shown), a capacitive charge holding capacitor (not shown), a radio receiver 190 and an electric shock circuit 200, and on the reverse side penetrating the underside of the wristband housing 55 two of the electrodes 220 electrically connected to the electric shock circuit 200. Additionally, an optional vibration transducer (well known in the art and not shown) may also be provided. Wrist engaging strap 160 has an outer surface 162, an inner surface 164, and at least one edge 166.

Electrical stimulation, of course, can be hazardous. In response to various levels of current, the human body experiences the following reactions:

| Current, milliamps | Reaction |
|---|---|
| 0.2 to 2.0 | Threshold of sensation |
| 10 to 15 | Constriction of muscles |
| 15 to 100 | Severe shock |
| 100 to 200 | Heart fibrillation |
| >200 | Cardiac arrest |

In “Product Safeness as A Design Parameter” by Paul W. Hill and Associates, Inc. (at website http://www.ewh.ieee.org/soc/pses/Downloads/newsletters/93v06n2.pdf) and published in “The Product Safety Newsletter” Vol. 6, No. 2 March-April 1993 by the Institute of Electrical and Electronics Engineers (IEEE) at page 4 and continuing at pages 10-14, it is noted that, for safety, current should be limited at the source and a general body resistance of about 1500 ohms can be assumed and used in design. There is a skin threshold voltage on the order of 25 to 35 volts below which current substantially will not flow. On this basis the range of current settable as a parameter in base unit 20 is 0.2 milliampere to a safe maximum of 14.0 milliamperes.

In normal use, current flow is restricted to a small region between electrodes 220. However because of the possibility of a user inadvertently touching one electrode 220 with one hand and the other electrode 220 with the other hand, allowing the current to flow through the body, it is important to reliably restrict the maximum current available to a safe maximum of 14 milliamperes. This wide range of adjustment is made available for the large range in user-to-user sensitivity to electric shock, allowing a user to customize the alarm signal.

Also included in FIG. 3 is a wrist engaging strap 160 that may be a Velcro type hook-and-loop material, or a strap with a common buckle closure, an expandable elastic material, or other closure means (not shown) known in the art.

FIG. 4 is a functional block diagram of the silent alarm wristband 50 which receives wireless communication radio waves 40 at radio receiver 190 which commands electric shock circuit 200 to produce a predetermined electric shock current by creating an appropriate voltage, and a predetermined time duration according to parameters received in the data stream and issued from processor and memory circuit 195. Such wireless communication means are well known in the art. These commands are issued to electric shock circuit 200 through electrical connection 205 which communicates electric shock pulse initiation, voltage, and duration. Power Supply 250 is a battery and may be rechargeable, the technology for which is also well known in the art, and provides power to all circuitry within silent alarm wristband 50.

A first preferred embodiment electric shock circuit 200 in response to commands described above charges a capacitor circuit, not shown, to a commanded voltage and subsequently connects the capacitor and a series current-limiting resistor, not shown, across electrodes 220 for a predetermined time as controlled with a timer such as a 555 timer integrated circuit, all well known in the art. A second preferred embodiment electric shock circuit 200 in response to commands described above connects battery 250 across a transformer, not shown, for a predetermined time in order to generate a desired output voltage function. The transformer secondary coil is connected to a series current-limiting resistor, not shown, and to electrodes 220. Other embodiments are anticipated wherein an electric shock circuit 200 causes a current-limited voltage function to be applied across electrodes 220 for a predetermined time, all within the scope of the present invention.

Deactivation pushbutton 170 signals the processor in 195 to enter a ‘snooze’ mode for a predetermined period of time and for appropriate first category alarms as described above.

FIG. 5 illustrates base unit 20 and sensors carbon monoxide 270, carbon dioxide 280, smoke 100, intrusion 110, and medical oxygen supply low pressure 130, a number of optional sensors and detectors 140, and a number of potential future unknown optional sensors and detectors 150 input to sensor input logic 290 which identifies the sensor alarm and category. Power supply 260 provides all power to base unit 20. Radio and alarm clock circuit 300 is readily available and well known in the electronics art, and directs audible alarm 320 when required. Program logic and memory is responsive to the sensor input logic 290 circuit and the clock alarm in 300. Display 60 provides help instructions and parameter display to aid the user when entering information with function and parameter pushbuttons 70. Radio transmitter 330 is driven by the program logic and memory 310 circuitry to issue parameter and alarm initiation data to the silent alarm wristband 50 via radio waves 40. Each of the functional electronic blocks described above is defined by these descriptions sufficiently for implementation by those skilled in the art.

While a particular form of the invention has been illustrated and described, it will be apparent that various modifications can be made without departing from the spirit and scope of the invention. For example, the term wristband and wrist may be construed as appendage-band and skin, thereby providing alternate preferred embodiments wherein the electric shock alarm is applied to the skin surface of an arm or a hand or a finger or a leg or an ankle or a toe, for example, all within the scope of the invention. Accordingly, it is not intended that the invention be limited, except as by the appended claims.

What is claimed is:

1. A wristband for waking a sleeping person, the wristband wirelessly cooperating with an electronic alarm device, the electronic alarm device producing a wireless alarm signal, the wristband comprising:
a wristband housing that includes a wrist engaging strap having an outside surface, and inside surface, and at least one edge surface, and an electronic circuit enclosure; and
an electronic circuit housed in the electronic circuit enclosure of the wristband, the electronic circuit including a plurality of electronic components comprising a power means, a wireless alarm signal receiving means, and an electrode means, all of the electronic components in electronic communication, the electrode means extending through the wristband housing to the inside surface of the wrist engaging strap;
whereby with the wristband fixed to the sleeping person's wrist such that the electrode means makes electrical contact with the person's wrist, upon detection of the wireless alarm signal, the wireless alarm signal receiving means causes power to be applied to the sleeping person through the electrodes, thereby waking the person.

2. The wristband of claim 1 wherein the power means includes a battery and a capacitive charge holding means, the electronic circuit capable of charging the capacitive charge holding means with the battery and subsequently partially discharging the capacitive charge holding means through the electrodes.

3. The wristband of claim 1 wherein the wristband housing includes a closure means for facilitating attachment and removal to the person's wrist.

4. The wristband of claim 3 wherein the closure means is a buckle.

5. The wristband of claim 3 wherein the closure means is a hook-and-loop type strap.

6. The wristband of claim 1 wherein the wristband is an expandable elastic material.

7. The wristband of claim 1 wherein the wireless alarm signal is an infrared signal.

8. The wristband of claim 1 wherein the wireless alarm signal is an ultrasonic signal.

9. The wristband of claim 1 wherein the wireless wake-up signal is a radio signal.

10. A wristband for waking a sleeping person, the wristband wirelessly cooperating with an electronic alarm device, the electronic alarm device producing a wireless alarm signal, the wristband comprising:
a wristband housing that includes a wrist engaging strap having an outside surface, an inside surface, and at least one edge surface, and an electronic circuit enclosure; and
an electronic circuit housed in the electronic circuit enclosure of the wristband, the electronic circuit including a plurality of electronic components comprising a power means, a wireless alarm signal receiving means, an electrode means, and a vibration means, all of the electronic components in mutual electronic communication, the electrode means extending through the wristband housing to the inside surface of the wrist engaging strap;
whereby with the wristband fixed to the sleeping person's wrist such that the electrode means makes electrical contact with the person's wrist, upon detection of the wireless alarm signal, the wireless alarm signal receiving means causes power to be applied to the vibration means and to the sleeping person through the electrodes, thereby waking the person.

11. A combination wristband and alarm clock for waking a sleeping person, the combination comprising:
a wristband housing that includes a wrist engaging strap having an outside surface, and inside surface, and at least one edge surface, and an electronic circuit enclosure; and
an electronic circuit housed in the electronic circuit enclosure of the wristband, the electronic circuit including a plurality of electronic components comprising a clock powering means, a wireless alarm signal receiving means, and an electrode means, all of the electronic components in mutual electronic communication, the electrode means extending through the wristband housing to the inside surface of the wrist engaging strap;
an alarm clock housing that includes a clock powering means, a clock electronic circuit, a display, a wireless alarm signal producing means, and an interface means, all in electronic communication, the alarm clock capable of calculating and displaying the current time, the interface means capable of establishing an alarm time;
whereby with the wristband fixed to the sleeping person's wrist such that the electrode means makes electrical contact with the person's wrist, upon the current time reaching the established alarm time the clock electronic circuit causes the wireless alarm signal producing means to be activated, and upon detection of the wireless alarm signal, the wireless alarm signal receiving means of the wristband causes power to be applied to the sleeping person through the electrodes, thereby waking the person.

12. The combination of claim 11 wherein the power means includes a battery and a capacitive charge holding means, the electronic circuit capable of charging the capacitive charge holding means with the battery and subsequently partially discharging the capacitive charge holding means through the electrodes.

13. The combination of claim 11 wherein the wristband housing includes a closure means for facilitating attachment and removal to the person's wrist.

14. The combination of claim 11 wherein the wristband is an expandable elastic material.

15. The combination of claim 11 wherein the wireless alarm signal is an infrared signal.

16. The combination of claim 11 wherein the wireless alarm signal is an ultrasonic signal.

17. The combination of claim 11 wherein the wireless alarm signal is a radio signal.

18. The combination of claim 11 wherein the clock powering means is a battery.

19. The combination of claim 11 wherein the clock powering means is household A/C current.
